(19) United States
(12) Patent Application Publication
(10) Pub. No.: US 2025/0241737 A1
(43) Pub. Date: Jul. 31, 2025

(54) MULTI-FUNCTIONAL FINGER WIPE

(71) Applicant: Shenglong Network Technology (Yangzhou) Co., Ltd., Yangzhou Jiangsu (CN)

(72) Inventor: Yong Wang, Shanghai (CN)

(21) Appl. No.: 18/427,863

(22) Filed: Jan. 31, 2024

(51) Int. Cl. A61D 5/00; A46B 5/04

(52) U.S. Cl. CPC A61D 5/00; A46B 5/04; A46B 2200/1086

(57) ABSTRACT

The utility model discloses a multifunctional cleaning finger wipe. The cleaning finger wipe is arranged to be connected into an integrated structure and includes: a first cleaning area and a second cleaning area. The first cleaning area and the second cleaning area are opposite to each other. The edge of the first cleaning area and the edge of the second cleaning area are combined with each other. The first cleaning area includes a first surface layer and concave and convex portions spaced along the first surface layer. The second cleaning area includes a first surface layer. The second surface layer and the second surface layer are provided with a number of plastic dripping parts. The plastic dripping parts and the concave and convex parts are made of different materials. This cleaning finger wipe can be used to clean the surface or deep cleaning of pet teeth according to different demands.

### TECHNICAL FIELD

The utility model relates to the field of pet tooth cleaning, in particular to a multifunctional cleaning finger wipe.

### BACKGROUND OF THE INVENTION

With the development of people's living standards, more and more people choose to raise pets. Oral hygiene is an important factor in the healthy growth of pets. From the perspective of pets' oral health, pets need to brush their teeth regularly after their permanent teeth have matured, clean the surface and deep food residues, tartar, plaque and other daily oral problems in teeth, gums, inter-dental spaces and other parts, maintain their oral hygiene, help prevent dental calculus and gingivitis, and reduce the probability of periodontal disease.

The cleaning finger wipes currently on the market are composed of a simple finger wipe and a flat cleaning paper towel connected to the outer wall of the finger wipe. Before use, the flat cleaning paper towel is moistened with water or cleaning fluid to enable cleaning ability. The surface of the flat cleaning paper towel rubs back and forth with the surface of the pet's teeth, gums and other parts to achieve a cleaning effect. However, this kind of cleaning finger wipe can only be used for surface cleaning of the pet's teeth, gums and other parts, and cannot effectively achieve deep cleaning.

### BRIEF SUMMARY OF THE INVENTION

Against the deficiencies in the existing technology, the utility model provides a multi-functional cleaning finger wipe, which can clean the surface or deep cleaning of pet teeth according to the people's requirements. It has multiple functions and strong practicability.

The utility model discloses a multifunctional cleaning finger wipe, which is configured to be connected as an integrated structure and includes: a first cleaning area and a second cleaning area, and the first cleaning area and the second cleaning area are arranged on opposite sides, the edge of the first cleaning area and the edge of the second cleaning area are adhered with each other, the first cleaning area includes a first surface layer and concave and convex portions spaced along the first surface layer, the second cleaning area includes a plurality of plastic dripping parts are provided on the second surface layer. The plastic dripping parts and the concave and convex parts are made of different materials. The color fastness to rubbing of the plastic dripping parts acting on the object to be cleaned is greater than the fastness of the concave and convex parts acting on the object to be cleaned.

Preferably, the concave and convex portions are configured as groove structures that are recessed inward from the outer surface of the first surface layer and capable of accommodating cleaning materials, or are configured as convex structures that protrude outward from the outer surface of the first surface layer, and each row is arranged adjacently. The two concave and convex parts are arranged at equal intervals, the two adjacent rows of concave and convex parts are arranged at equal intervals, and the two adjacent rows of concave and convex parts are crossed.

Preferably, the plastic dripping part is configured as a protruding point structure protruding on the outer surface of the second surface layer. Two plastic dripping parts arranged adjacently in each row are arranged at equal intervals. They are arranged at equal intervals, and the two adjacently arranged plastic drop parts are arranged in a cross structure. The outer surface of the plastic drop part is coated with a glue layer.

Preferably, the shape of the plastic dripping part includes any one of a partial sphere, a partial ellipsoid, a cube or an irregular body, the hardness of the plastic dripping part is greater than the hardness of the concave and convex parts, and the plastic dripping part acts on the color fastness to rubbing of the object to be cleaned is 4.0-5.0.

Preferably, the edges of the first cleaning area and the second cleaning area are adhered by ultrasonic waves, the thickness of the first cleaning area is 0.1-2 mm, and the thickness of the second cleaning area is 0.1-2 mm.

Preferably, the outer surface material of the first cleaning area and the second cleaning area contains hydrophilic-treated non-woven fabric at least one of rayon fiber, cotton fiber, polyester fiber, and acrylic fiber; and/or, the inner surface material of the first cleaning area and the second cleaning area contains at least one of rayon fiber, polyester fiber, and acrylic fiber.

Preferably, the inner surfaces of the first cleaning area and the second cleaning area are provided with waterproof membranes.

Preferably, the outer surfaces of the first cleaning area and the second cleaning area contain cleaning materials.

The utility model also discloses a multifunctional cleaning finger wipe, which includes a finger wipe body, and one end of the finger wipe body is set as a closed structure. The closed structure is in an arc shape, and the other end is set as an open structure. The finger wipe body is formed by combining the first cleaning area and the second cleaning area. The space from the opening structure to the closed structure forms a covering area for the operator to put on the finger. When the covering area is put on the operator's finger, the first cleaning area is used for surface cleaning of the object, and the second cleaning area is used for deep cleaning of the object.

Preferably, the edges of the first cleaning area and the second cleaning area are adhered by ultrasonic waves, the thickness of the first cleaning area is 0.1-2 mm, the width is 20-40 mm, and the thickness of the second cleaning area is 0.1-2 mm, width is 20-40 mm.

In the cleaning finger wipe disclosed by the present utility model, since the friction coefficient of the plastic dripping part acting on the teeth and gums waiting for cleaning is greater than the friction coefficient of the concave and convex parts acting on the teeth and gums waiting for cleaning, the concave and convex parts of the first cleaning area can be used to clean the finger cot. Food residues on the surface of pet teeth, gums and other parts can be gently cleaned with relatively low friction to achieve the effect of surface cleaning of teeth, gums and other parts. The design of the concave and convex parts is conducive to locking in moisture and taking away food residues. Compared with The flat cleaning paper towels in the existing technology can clean food residues more quickly, and can also use the plastic dispensing part of the second cleaning area to remove tartar, plaque and other stubborn stains on pet teeth, gums and other parts, as well as in the gaps between teeth. It can clean the food residues with relatively high friction and achieve the effect of deep cleaning of teeth, gums, inter-dental spaces and other parts. When using, you can choose surface cleaning or deep cleaning according to your needs. It has multiple functions and strong practicability.

Additional aspects and advantages of the invention will be set forth in part in the description which follows, and in part will be obvious from the description, or may be learned by practice of the invention.

### BRIEF DESCRIPTION OF THE DRAWINGS

The drawings described here are used to provide a further understanding of the present utility model and constitute a part of the present application. The schematic embodiments of the present utility model and their descriptions are used to explain the present utility model and do not constitute an improper limitation of the present utility model. In the attached picture:

FIG. 1 is a schematic structural diagram of the cleaning finger wipe disclosed in one embodiment of the present invention.

FIG. 2 is a front view of the cleaning finger wipe disclosed in one embodiment of the present invention.

FIG. 3 is a back view of the cleaning finger wipe disclosed in one embodiment of the present invention.

FIG. 4 is a schematic diagram of cross-sectional structure of the cleaning finger wipe disclosed in one embodiment of the present invention.

### DETAILED DESCRIPTION OF THE INVENTION

In order to make the purpose, technical solutions and advantages of the embodiments of the present utility model more clear, the technical solutions of the embodiments of the present utility model will be clearly and completely described below with reference to the drawings of the embodiments of the present utility model. Obviously, the described embodiments are some, but not all, of the embodiments of the present invention. Based on the described embodiments of the present utility model, all other embodiments obtained by those of ordinary skill in the art without creative efforts fall within the scope of protection of the present utility model.

In the description of the present utility model, it should be understood that the terms “upper”, “lower”, “front”, “back”, “left”, “right”, “top”, “bottom”, “inner”, The orientation or positional relationship indicated by “outside” is based on the orientation or positional relationship shown in the drawings. It is only for the convenience of describing the present invention and simplifying the description, and does not indicate or imply that the device or component referred to must have a specific orientation, is constructed and operated in a specific orientation, and therefore cannot be construed as a limitation of the present invention.

In this utility model, unless otherwise expressly stipulated and limited, the terms “installation”, “connection”, “contact”, “fixing” and other terms should be understood in a broad sense. For example, it can be a fixed connection or a detachable connection, or integral connection; it can be a mechanical connection or an electrical connection; it can be a direct connection or an indirect connection through an intermediate medium; it can be an internal connection between two components. For people of ordinary skill in the art, the specific meanings of the above terms in the present invention can be understood according to specific circumstances.

In the present invention, unless otherwise expressly stipulated and limited, the first feature being “above” or “below” the second feature may include direct contact between the first and second features, or may include the first and second features being in direct contact with each other. Features are not in direct contact, but through other features between them. Furthermore, the terms “above”, “upward” and “over” a first feature on a second feature include the first feature being directly above and diagonally above the second feature, or simply mean that the first feature is higher in level than the second feature. “Below”, “under” and “downward” the first feature is the second feature includes the first feature being directly below and diagonally below the second feature, or simply means that the first feature is less horizontally than the second feature.

Unless otherwise defined, technical terms or scientific terms used herein shall have the usual meaning understood by a person with ordinary skills in the field to which this invention belongs. “first”, “second” and similar words used in the specification and claims of the patent application of the present invention do not indicate any order, quantity or importance, but are only used to distinguish different components. Likewise, “a” or “one” and similar words do not indicate a quantitative limit, but rather indicate the presence of at least one.

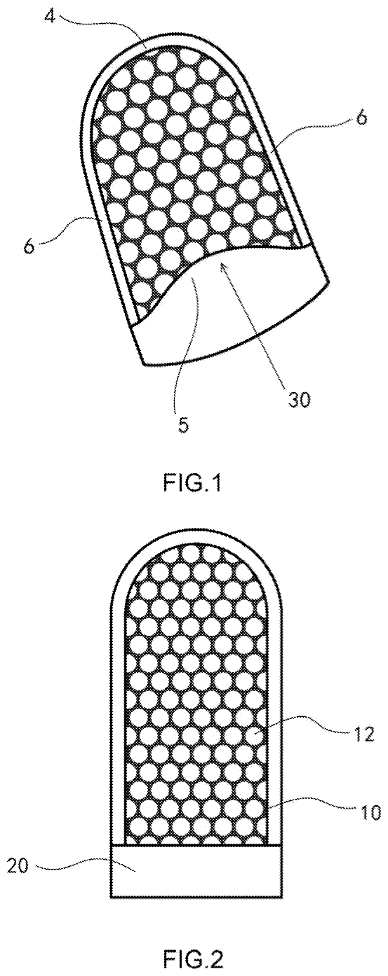

As shown in FIGS. 1-4, as an embodiment of the present utility model, a multifunctional cleaning finger wipe is disclosed, which is mainly used for cleaning the oral cavity of pets, and can also be used for oral cleaning of babies or adults, or for makeup and makeup removal, apply medicine and other functions. The cleaning finger wipe is configured as a connected integrated structure, including the first cleaning area 10 and the second cleaning area 20. The first cleaning area 10 and the second cleaning area 20 are arranged on opposite sides. The edges of the first cleaning area 10 and the edges of the second cleaning area 20 are adhered with each other. The first cleaning area 10 includes a first surface layer 11 and a plurality of concave and convex portions 12 spaced along the first surface layer 11. The second cleaning area 20 includes a second surface layer 21 and a plurality of concave and convex portions 12 spaced along the first surface layer 11. A number of drop molding parts 22 are provided. The plastic dripping part 22 and the concave and convex parts 12 are made of different materials. The friction coefficient of the plastic dripping part 22 acting on the teeth and gums waiting to be cleaned is greater than the friction coefficient of the concave and convex part 12 acting on the teeth and gums waiting to be cleaned, so that the concave and convex parts 12 of the cleaning area 10 can gently clean the food residues on the surface of the pet's teeth, gums and other parts with relatively low friction, achieving the effect of surface cleaning of the teeth, gums and other parts. The design of the concave and convex parts 12 is conducive to locking in moisture, and take away food residues. Compared with the flat cleaning paper towels in the prior art, the food residues can be cleaned more quickly. The plastic dispensing part 22 of the second cleaning area 20 can also be used to remove tartar and other dirt from pet teeth, gums and other parts. Stubborn stains such as dental plaque, as well as food residues in the gaps between teeth can be cleaned vigorously with relatively high friction to achieve the effect of deep cleaning of teeth, gums, gaps between teeth and other parts. You can choose surface cleaning or deep cleaning according to your needs. Clean, versatile and practical.

As shown in FIG. 4, in some specific embodiments, the concave and convex portions 12 are configured as groove structures formed by being recessed inwardly from the outer surface of the first surface layer 11 and capable of accommodating cleaning materials such as food residues, tartar, and dental plaque, and are more effective. It is beneficial to bring out the cleaning materials and achieve the effect of rapid surface cleaning. At the same time, the partial structure of the first surface layer 11 between the two adjacent concave and convex parts 12 can absorb and lock moisture, making cleaning convenient. As another embodiment of the present invention, the concave-convex portion 12 is configured as a convex structure protruding outward from the outer surface of the first surface layer 11. The convex structure can also lock in moisture and bring out cleaning materials. In some specific embodiments, the plastic dripping part 22 is configured as a bump structure protruding on the outer surface of the second surface layer 21, which is conducive to more powerful removal of stubborn stains such as tartar and plaque on pet teeth, gums and other parts. Cleaning, while the raised point structure design also helps to bring out food residues in the teeth, thereby achieving deep cleaning. The concave and convex parts 12 are directly pressed and formed on the first cleaning area 10 and are made of the same flexible material as the first cleaning area 10. The plastic dripping part 22 is made of a solid material made of thermoplastic polymer material drip molding, which facilitates processing and production and ensures that the plastic dripping part 22 hardness.

In some specific embodiments, the color fastness to rubbing of the concave and convex portion 12 acting on the teeth and gums waiting to be cleaned is 3-4, and the color fastness to rubbing of the plastic dripping portion 22 acting on the teeth and gums waiting to be cleaned is 4-5, and the cleaning effect is good. The hardness of the plastic dripping part 22 is greater than the hardness of the concave and convex parts 12, which is conducive to more powerful cleaning of stubborn stains such as tartar and plaque on pet teeth, gums and other parts. The outer surface of the plastic dispensing part 22 is coated with a glue layer, which is used to increase the friction of the plastic dispensing part 22 on the teeth, gums and other cleaning objects, so as to achieve more powerful cleaning.

As shown in FIG. 2, in some specific embodiments, the two adjacently arranged concave and convex portions 12 in each row are arranged at equal intervals, and the two adjacently arranged rows of the concave and convex portions 12 are arranged at equal intervals, and each two adjacent rows of concave and convex portions 12 are arranged in a staggered manner, so that each concave and convex portion 12 is arranged in a network on the first surface layer 11, arranged neatly, evenly, densely and compactly, which facilitates cleaning of the surface layer. The distance between two adjacently arranged concave and convex parts 12 is less than the radial width of the concave and convex parts 12, and the concave and convex parts 12 have a large area, so that the groove structure can accommodate more food residues, tartar, dental plaque and other cleaning materials. Or the raised structure can absorb and lock more moisture, which is more conducive to rapid surface cleaning.

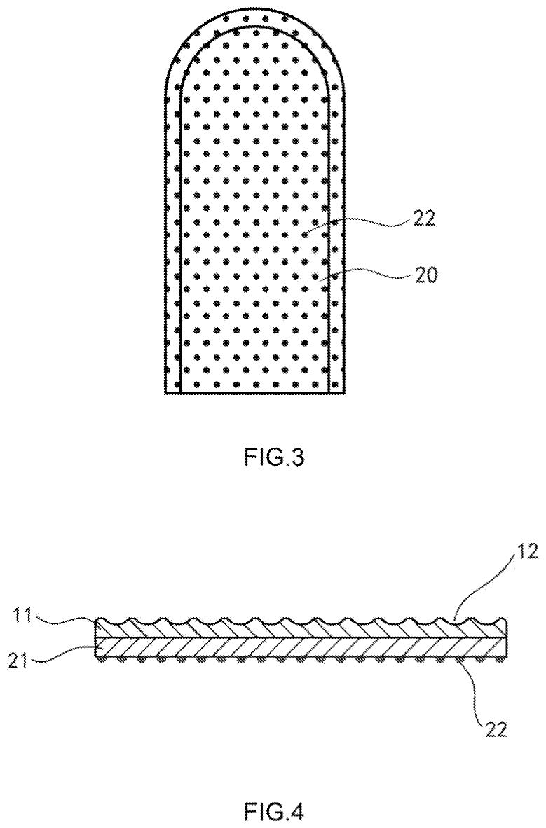

As shown in FIG. 3, in some specific embodiments, the two adjacent rows of plastic drop parts 22 are arranged at equal intervals, and the two adjacent rows of plastic drop parts 22 are arranged at equal intervals. Moreover, the two adjacently arranged plastic drop parts 22 are arranged in a staggered manner, so that each plastic drop part 22 is arranged in a network shape on the second surface layer 21, arranged neatly and evenly, and is convenient for deep cleaning. The distance between two adjacently arranged plastic drop parts 22 is greater than the radial width of the drop mold part 22, and the area of the drop mold part 22 is small, thereby ensuring that the bump structure has relatively strong resistance to rub stubborn tartar, dental plaque, etc. It also allows the convex point structure to penetrate into small gaps such as between teeth for deep cleaning.

As shown in FIGS. 2 and 4, in some specific embodiments, the shape of the concave and convex portions 12 is set to be circular, that is, a pearl pattern. The structure is simple and practical, and is convenient for production. In other embodiments, the shape of the concave and convex portion 12 can also be set to any one of triangle, square, pentagon, hexagon or irregular shape.

As shown in FIGS. 3 and 4, in some specific embodiments, the shape of the plastic drop part 22 is set as a hemisphere, which has a simple and practical structure and facilitates production. In other embodiments, the plastic dispensing part 22 can also be configured as any one of a partial sphere, a partial ellipsoid, a cube or an irregular body with other proportions such as ⅓, ¼, ¾, etc.

As shown in FIG. 1, in some specific embodiments, the cleaning finger wipe includes a finger wipe body formed by a first cleaning area 10 and a second cleaning area 20 combined with each other, and one end of the finger wipe body is set as a closed structure 4, the closing structure 4 is arranged in an arc shape, which is suitable for the fingers and is not easy to scratch the pet's mouth. The other end is set as an opening structure 5. Both sides of the finger wipe body are respectively set as closed extending from the closing structure 4 to the closed edge 6 of the opening structure 5. The space from the opening structure 5 to the closed structure 4 forms a fitting area 30 for the operator to put on the fingers and other fingers. When the fitting area 30 is put on the operator's fingers, the first cleaning area 10 is selected for pet teeth. For surface cleaning of objects such as pet teeth, the second cleaning area 20 is selected for deep cleaning of objects such as pet teeth.

In some specific embodiments, the shape of the first cleaning area 10 is adapted to the shape of the second cleaning area 20, and the length of the first cleaning area 10 is smaller than the length of the second cleaning area 20, which facilitates the operator's fingers to insert into the suit within area 30.

In some specific embodiments, the edges of the first cleaning area 10 and the second cleaning area 20 are bonded by ultrasonic waves, which is convenient for producing. The cleaning finger wipe is formed into a flat sheet structure before use, which is convenient for packaging. Disposable design, the single-piece product can be discarded after use, ensuring healthy and hygienic use.

In some specific embodiments, the thickness of the first cleaning area 10 is 0.1-2 mm, preferably 0.5 mm, and the width of the first cleaning area is 20-40 mm, preferably 25 mm. The thickness of the second cleaning area 20 is 0.1-2 mm, preferably 1.5 mm, and the width of the second cleaning area 20 is 20-40 mm, preferably 25 mm.

In some specific embodiments, the outer surfaces of the first cleaning area 10 and the second cleaning area 20 are hydrophilically treated non-woven fabrics, and the non-woven fabrics contain one or more materials selected form rayon fibers, cotton fibers, polyester fibers, and acrylic fibers, which are easy to absorb and lock in moisture, and the cleaning effect is better.

In some specific embodiments, the inner surfaces of the first cleaning area 10 and the second cleaning area 20 are made of one or more materials selected from rayon fiber, polyester fiber, and acrylic fiber. The outer surface of the cleaning area 20 is adapted to facilitate production. In other specific embodiments, the inner surfaces of the first cleaning area 10 and the second cleaning area 20 are provided with waterproof membranes to prevent water, pet saliva or cleaning fluid from penetrating into the first cleaning area 10 and the second cleaning area 20 The suit area 30 between them avoids contamination of the operator's fingers.

In some specific embodiments, the outer surfaces of the first cleaning area 10 and the second cleaning area 20 contain cleaning materials, and the cleaning materials contain one or more substance selected from the group consisting of water, moisturizer, deodorant, and care agent, so that the cleaning finger wipe itself has cleaning ability, so there is no need to dip it in water, moisturizer, deodorant, care agent and other substances before use, making it easy to use directly.

Finally, it should be noted that the above embodiments are only used to illustrate the technical solution of the present invention, but not to limit it; although the present utility model has been described in detail with reference to the foregoing embodiments, those of ordinary skill in the art should understand that: The technical solutions described in the foregoing embodiments can still be modified, or some of the technical features can be equivalently replaced; and these modifications or substitutions do not cause the essence of the corresponding technical solutions to deviate from the scope of the technical solutions of the various embodiments of the present invention.

In short, the above descriptions are only preferred embodiments of the present utility model. All equal changes and modifications made in accordance with the patent application scope of the present utility model shall fall within the scope of the patent of the present utility model.

What is claimed is:

1. A multifunctional cleaning finger wipe, characterized in that it is arranged to be connected into an integrated structure, including: a first cleaning area and a second cleaning area, the first cleaning area and the third cleaning area. Two cleaning areas are arranged on opposite sides, and the edge of the first cleaning area and the edge of the second cleaning area are combined with each other. The first cleaning area includes a first surface layer and concave and convex portions spaced along the first surface layer. The second cleaning area includes a second surface layer and a plurality of plastic dripping parts on the second surface layer. The plastic dripping parts and the concave and convex parts are made of different materials. The friction coefficient of the plastic dripping part is greater than that of the concave and convex parts.

2. According to claim 1, the multifunctional cleaning finger wipe, wherein the concave and convex portions are configured as groove structures that are recessed inwardly from the outer surface of the first surface layer and capable of accommodating cleaning materials, or are configured as recessed portions from the first surface layer. A convex structure formed by protruding outward from the outer surface of a surface. Two adjacent concave and convex parts in each row are arranged at equal intervals. The two rows of concave and convex portions are arranged in cross.

3. According to claim 1, the multi-functional cleaning finger wipe, characterized in that: the plastic dripping part is configured as a raised point structure protruding on the outer surface of the second surface layer, and one of the two plastic dripping parts arranged adjacently in each row. The two adjacent rows of plastic dripping parts are arranged at equal intervals, and the two adjacent rows of plastic dripping parts are in cross. The outer surface of the plastic dripping parts is coated with adhesive layer.

4. According to claim 1, the multifunctional cleaning finger wipe, characterized in that: functional fibers are also distributed inside the first cleaning area and the second cleaning area, and the functional fibers include antibacterial fiber, deodorizing fiber, anti-mite fiber, mildew-resistant fiber or moisture-absorbent, quick-drying fiber.

5. According to claim 1, the multifunctional cleaning finger wipe characterized in that: the shape of the plastic injection part includes any of a partial sphere, a partial ellipsoid, a cube or an irregular body. One, the hardness of the plastic dripping part is greater than the hardness of the concave and convex parts, and the color fastness to rubbing of the plastic dripping part acting on the object to be cleaned is 4.0-5.0

6. According to claim 1, the multifunctional cleaning finger wipe, characterized in that: the edges of the first cleaning area and the second cleaning area are adhered by ultrasonic waves. The thickness of the first cleaning area is 0.1-2 mm while the thickness of the second cleaning area is 0.1-2 mm.

7. According to claim 1, the multifunctional cleaning finger wipe characterized in that: the outer surface material of the first cleaning area and the second cleaning area contains at least one of hydraulically treated non-woven fabrics made of rayon fiber, cotton fiber, polyester fiber, and acrylic fiber, and/or
The inner surface material of the first cleaning area and the second cleaning area contains at least one of rayon fiber, polyester fiber, and acrylic fiber.

8. According to claim 6, the multifunctional cleaning finger wipe characterized in that: the inner surfaces of the first cleaning area and the second cleaning area are both provided with waterproof membrane.

9. According to claim 6, the multifunctional cleaning finger wipe wherein the outer surfaces of the first cleaning area and the second cleaning area contain cleaning materials.

10. A multifunctional cleaning finger wipe, which is characterized in that: it includes a finger wipe body, one end of the finger wipe body is set as a closed structure, the closed structure is arranged in an arc shape, and the other end is set as an open structure. The multifunctional cleaning finger wipe is formed by combining the first cleaning area and the second cleaning area. The space from the opening structure to the closed structure forms a covering area for the operator to put on the finger. When the covering area is put on by the operator, the first cleaning area is used for surface cleaning of the object, and the second cleaning area is used for deep cleaning of the object.

11. According to claim 10, the multifunctional cleaning finger wipe characterized in that: the edges of the first cleaning area and the second cleaning area are adhered by ultrasonic waves, and the thickness of the first cleaning area is 0.1-2 mm, the width is 20-40 mm, the thickness of the second cleaning area is 0.1-2 mm, and the width is 20-40 mm.
